(19) United States
(12) Patent Application Publication
(10) Pub. No.: US 2018/0121076 A1
(43) Pub. Date: May 3, 2018

(54) DRAWING PROCESSING METHOD, DRAWING PROGRAM, AND DRAWING DEVICE

(71) Applicant: GREE, Inc., Tokyo (JP)

(72) Inventors: Kazuaki Hamada, Tokyo (JP); Gijun Han, Tokyo (JP); Shigeki Nakamura, Tokyo (JP)

(73) Assignee: GREE, Inc., Tokyo (JP)

(21) Appl. No.: 15/785,150

(22) Filed: Oct. 16, 2017

(30) Foreign Application Priority Data
Oct. 17, 2016 (JP) 2016-203954

(51) Int. Cl. G06F 3/0488; G06F 3/0484

(52) U.S. Cl. CPC G06F 3/04883; G06T 11/203; G06F 3/04845

(57) ABSTRACT

A drawing processing method of controlling a drawing processing apparatus, the method including: receiving a first touch operation of tapping a first location on a touch panel display; storing, in a memory, the first location as a drawing start location; receiving a second touch operation of sliding on the touch panel display from a second location to a third location to draw a first slide trajectory, the second location being different from the first location; storing, in the memory, the second location as an operation start location; and based on the drawing start location and the operation start location, displaying an object of a second slide trajectory corresponding to the first slide trajectory drawn by the second touch operation such that the displayed object of the second slide trajectory starts from the drawing start location.

### CROSS-REFERENCE TO RELATED APPLICATIONS

This application claims priority to Japanese Application No. 2016-203954, filed Oct. 17, 2016, the entire contents of which are incorporated herein by reference.

### FIELD

This disclosure relates to a drawing processing method, drawing program, and drawing device for supporting drawing in a computer terminal.

### BACKGROUND

In a computer terminal such as a tablet terminal or the like, a variety of operations are performed on a touch panel display. Using a touch panel display of this kind makes it possible to perform operations intuitively. Hence, technologies have been disclosed for implementing touch operations over the entirety of a touch panel in a portable terminal device furnished with a touch panel-style display portion (for example, Patent Literature 1). In the technology described in this document, when a change in the tilt of the terminal is detected, the direction of tilt is determined, and based on the results of this determination, the display position of a screen containing operators associated with operations on a touch panel is moved to enable operation of the operators.

Furthermore, technology for producing drawn images by touch operations have also been studied (for example, Patent Literature 2). The touch operation input device described in this document enables input by means of touch operations on a display screen, and is furnished with a touch operation detection portion that detects touch operations and a control processing portion that performs processing after determining, based on the detection results from the touch operation detection portion, the specifics of an operation. Based on the results of determination of the specifics of an operation, processing is performed for menu display and menu items, or, in the case of draw mode, generating a drawn image at the touched portion. If the touch operation is determined to be a menu processing operation, the image processing portion erases the image drawn by touch operation, even in draw mode.

### PRIOR ART LITERATURE

### Patent Literature

(Patent literature 1) Japanese Unexamined Patent Application Publication No. 2014-149653

(Patent literature 2) Japanese Unexamined Patent Application Publication No. 2015-207040

### SUMMARY

According to one aspect of the disclosure, there is provided a non-transitory computer readable medium including executable instructions, which when executed by a computer cause the computer to execute a drawing processing method of controlling a drawing processing apparatus including a touch panel display, the method comprising: receiving, via the touch panel display, a first touch operation, the first touch operation tapping a first location on the touch panel display; storing, in a memory, the first location as a drawing start location; after storing the first location as the drawing start location, receiving, via the touch panel display, a second touch operation, the second touch operation sliding on the touch panel display from a second location to a third location to draw a first slide trajectory, the second location being different from the first location; storing, in the memory, the second location as an operation start location; and based on the drawing start location and the operation start location stored in the memory, controlling the touch panel display to display an object of a second slide trajectory corresponding to the first slide trajectory drawn by the second touch operation such that the displayed object of the second slide trajectory starts from the drawing start location.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

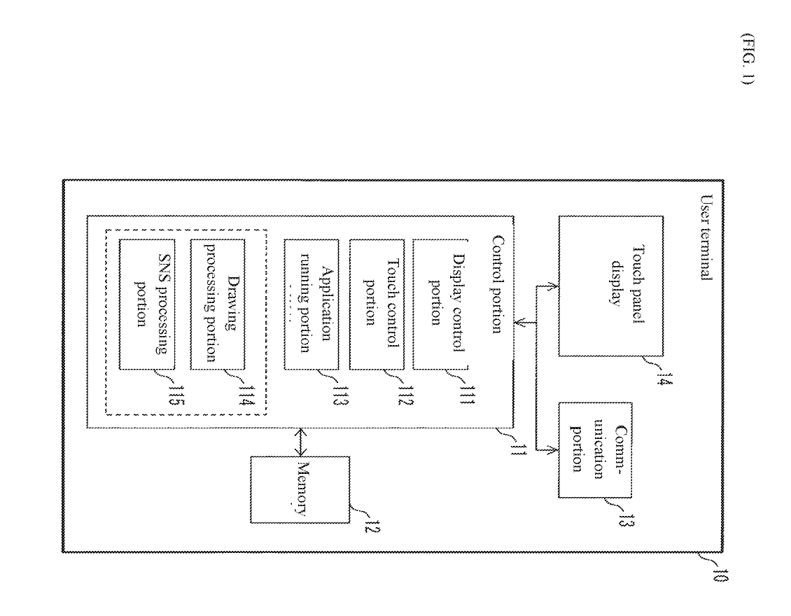

(FIG. 1) Functional block drawing of the first embodiment of the drawing device.

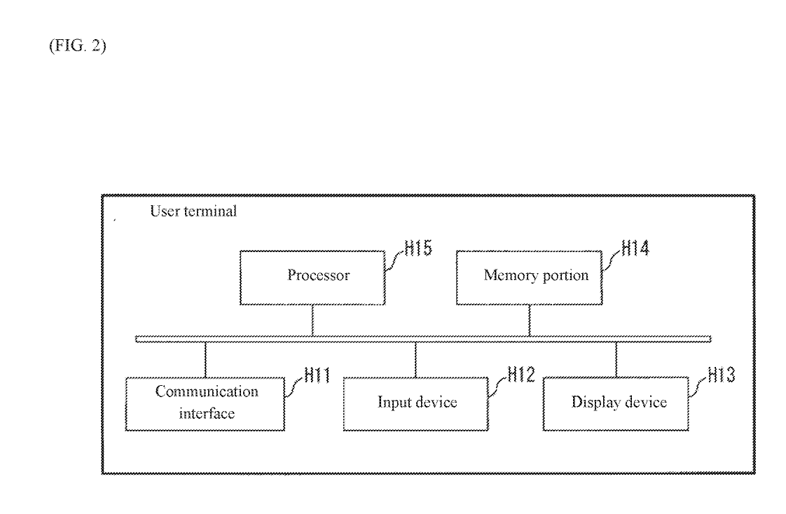

(FIG. 2) Illustration of an example of the hardware configuration of a drawing device.

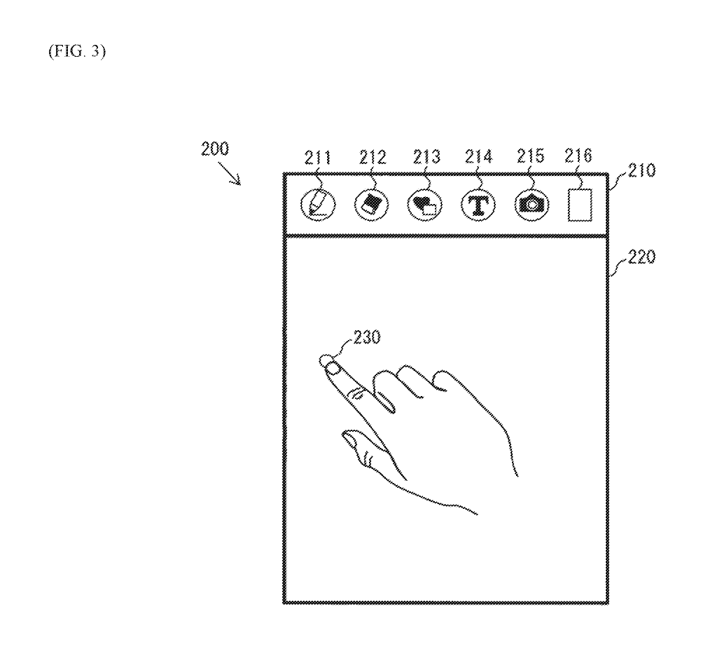

(FIG. 3) Illustration of the display screen on the touch panel display in the first embodiment

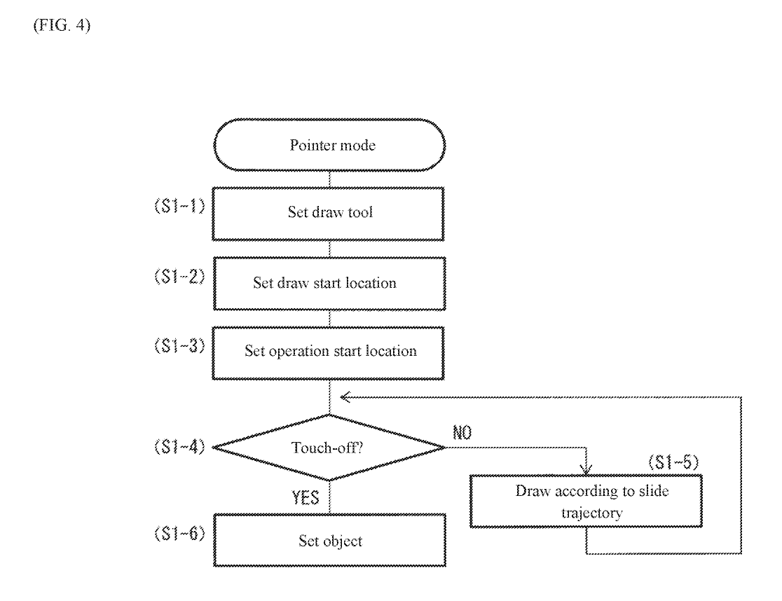

(FIG. 4) Illustration of the processing procedure in the first embodiment.

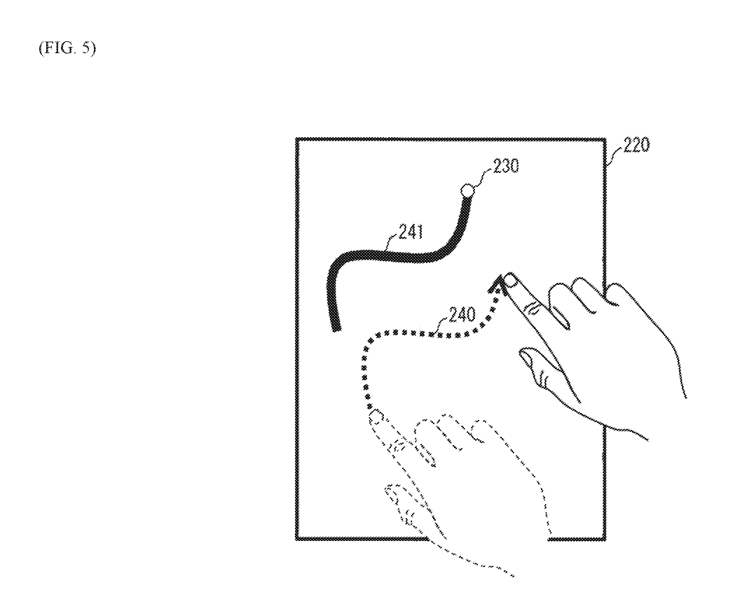

(FIG. 5) Illustration of the display screen on the touch panel display in the first embodiment.

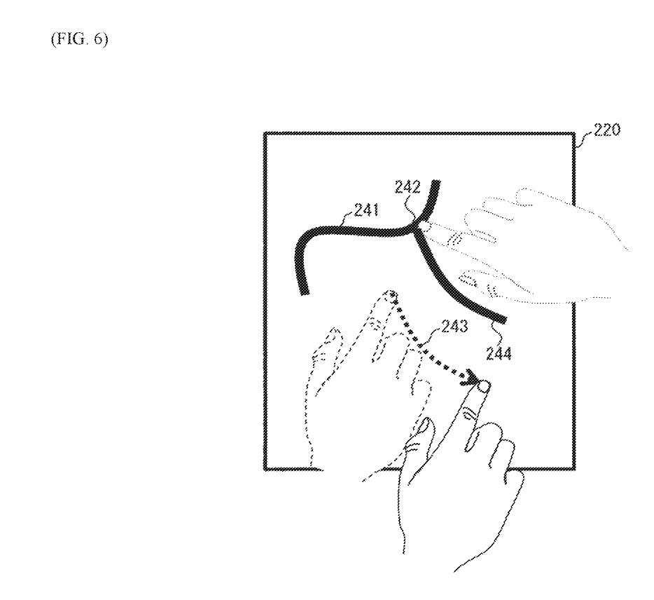

(FIG. 6) Illustration of the display screen on the touch panel display in the first embodiment.

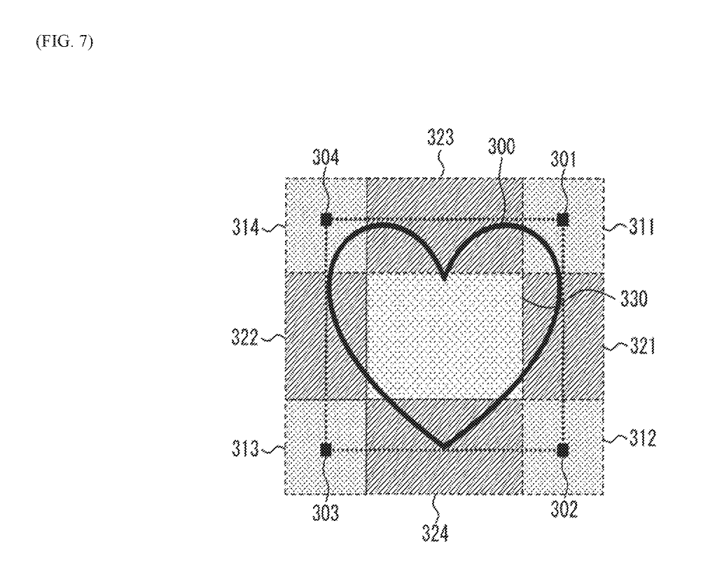

(FIG. 7) Illustration of the operation area in the second embodiment.

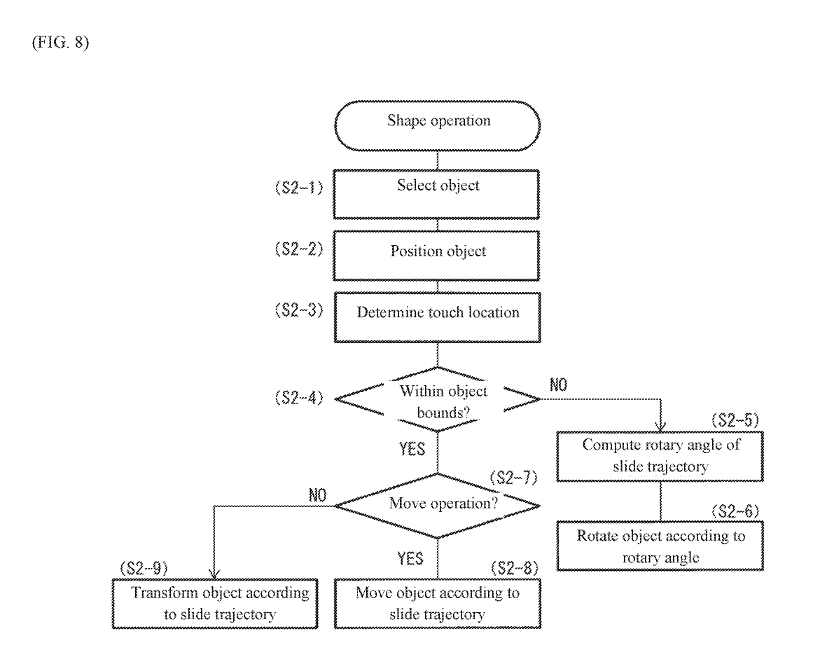

(FIG. 8) Illustration of the processing procedure in the second embodiment.

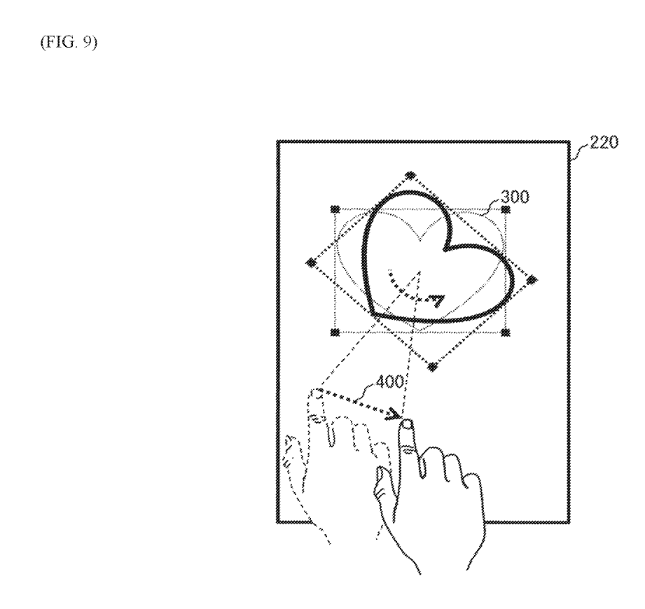

(FIG. 9) Illustration of the display screen on the touch panel display in the second embodiment.

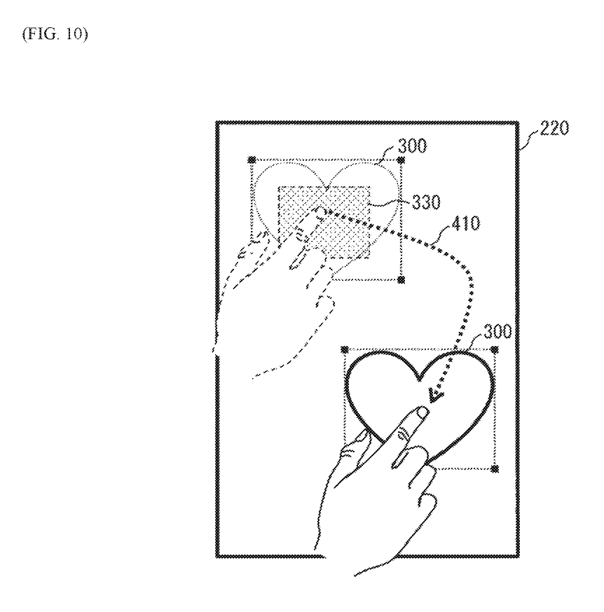

(FIG. 10) Illustration of the display screen on the touch panel display in the second embodiment.

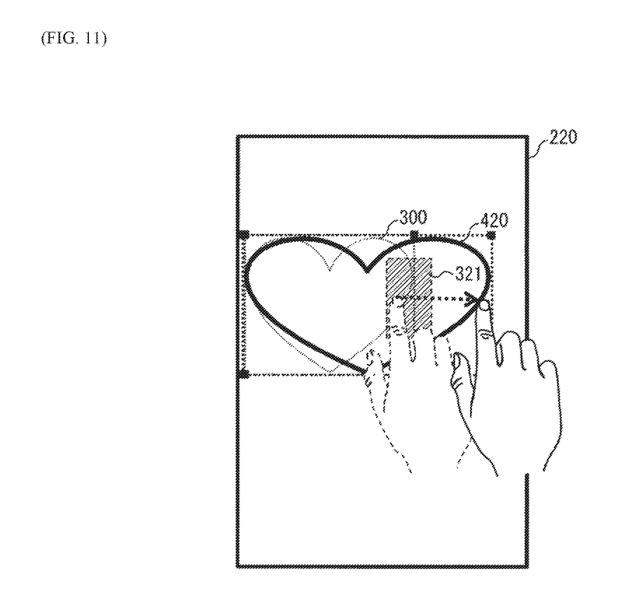

(FIG. 11) Illustration of the display screen on the touch panel display in the second embodiment.

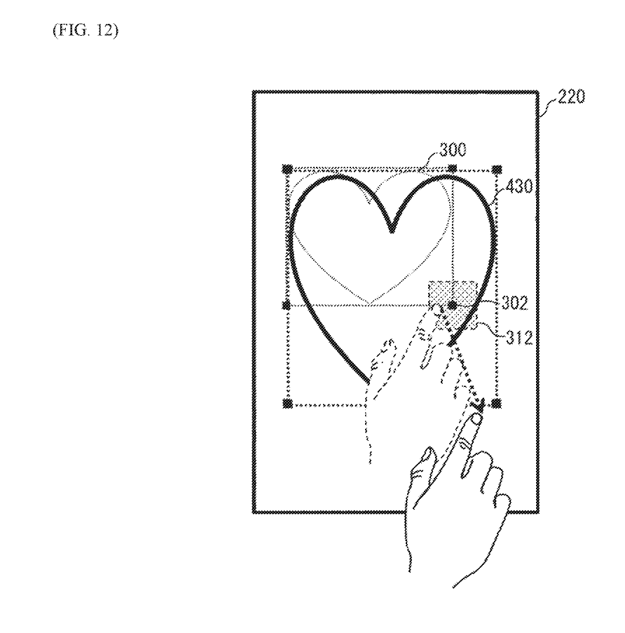

(FIG. 12) Illustration of the display screen on the touch panel display in the second embodiment.

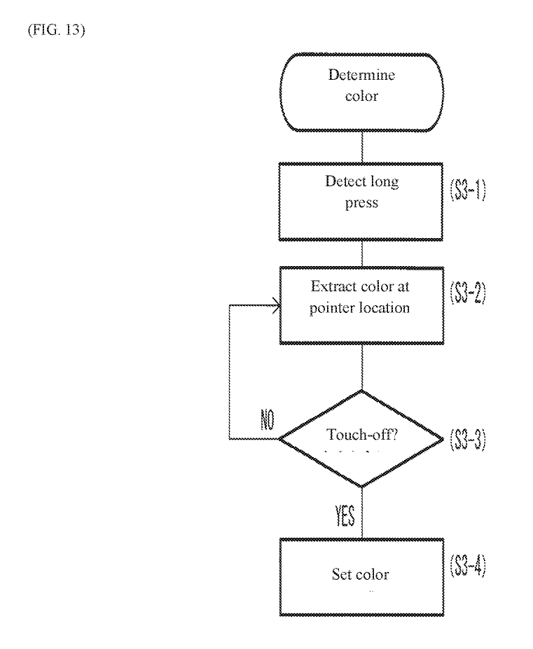

(FIG. 13) Illustration of the processing procedure in the third embodiment.

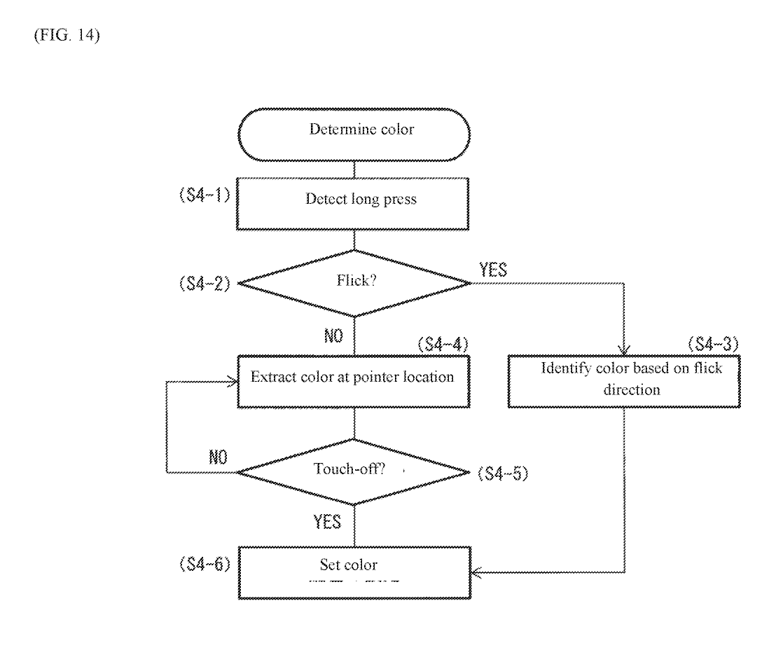

(FIG. 14) Illustration of the processing procedure in the fourth embodiment.

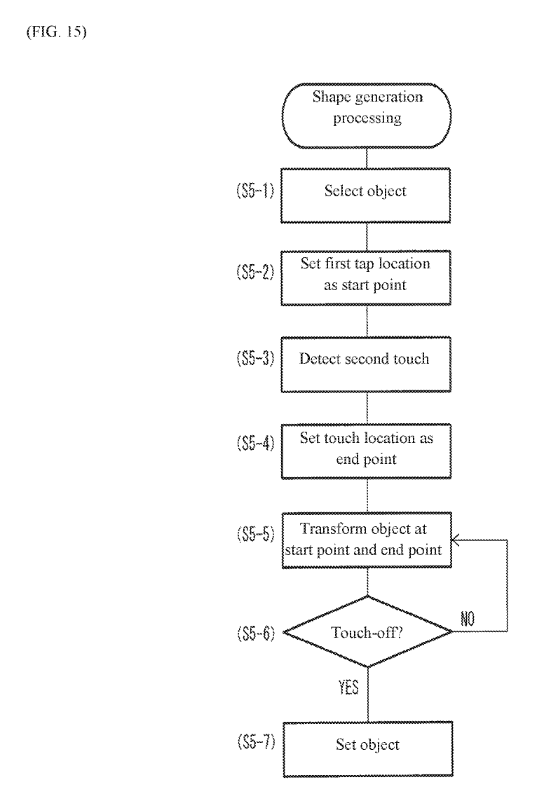

(FIG. 15) Illustration of the processing procedure in the fifth embodiment.

### DETAILED DESCRIPTION

### Problem to be Solved by the Disclosure

However, in a touch panel display, when a touch operation is performed with a finger or the like, it can be challenging to perform operations accurately. For example, if the touch panel display is relatively small and the display area is also small relative to the size of the fingertip, the information displayed on the touch panel display can be obscured by the finger, making it challenging to perform operations accurately. Although the images displayed on the touch panel display could be enlarged for operation, enlarging the image requires effort and is not an efficient means of implementing operations.

This disclosure was devised to solve the aforesaid problems, having as its objective to provide a drawing processing method, drawing processing program, and drawing processing device for supporting efficient and accurate drawing.

### Means of Solving the Problem

The drawing processing method that solves the aforesaid problem controls a drawing device furnished with a display portion and control portion capable of touch input. Upon detecting that line drawing has been selected for a drawing operation, the aforesaid control portion identifies the drawing starting point for the aforesaid line drawing, and generates an object for a line drawing drawn according to the path from the operation start location, which is located a certain distance from the aforesaid drawing start location. This makes it possible to draw by performing operations at a location different from the drawing area. Accordingly, this makes it possible to perform drawing efficiently and accurately by preventing the drawing area from being obscured by the finger or the like during a touch operation.

In the aforesaid drawing processing method, if the shape drawing selection is detected, it is preferred that the aforesaid control portion identifies the location where the shape object is situated, and determines the placement of the aforesaid shape object according to the path from the operation start location, which is located a certain distance from the aforesaid location where the shape object is situated. This makes it possible to set a shape in an area a certain distance from the area where the shape is located while checking the positioning of the shape.

In the aforesaid drawing processing method, if an instruction to erase a portion of an object is detected, it is preferred that the erase start position is determined, and part of the aforesaid object is erased according to the path from the operation start location, which is located a certain distance from the aforesaid erase start location. This makes it possible to efficiently and accurately perform erase operations in areas a certain distance from the erase area.

In the aforesaid drawing processing method, it is preferred that a plurality of operation areas are set relative to the location of the aforesaid object, and the aforesaid object is subjected to different operations depending on which of the operation areas has been selected. This makes it possible to efficiently perform operations on an object,

In the aforesaid drawing processing method, it is preferred that the spread angle of the path from the operation start location is calculated for a reference position within the aforesaid object, and rotation operations are performed on the aforesaid object based on the aforesaid spread angle. This makes it possible to perform rotation operations on an object from an area a certain distance from the object.

In the aforesaid drawing processing method, it is preferred that the attributes of the object situated at the location where the aforesaid display portion was touched are determined and displayed in an attribute display area, and that when touch-off of the aforesaid touch is detected, the aforesaid attributes are set as the attributes for drawing. This makes it possible to view the attributes in an area different from the touch location.

In the aforesaid drawing processing method, it is preferred that attribute candidates are output around the aforesaid touch location, and the attributes to use during drawing are determined from among the aforesaid attribute candidates according to the aforesaid touch-off direction. This makes it possible to efficiently determine the attributes.

In the aforesaid drawing processing method, if an object with a set start point and end point is selected, it is preferred that the aforesaid start point is set to the touch location, the aforesaid end point is set to the touch location of a slide operation, the aforesaid object is output to the aforesaid display portion, and the shape of the aforesaid object is determined at touch-off. This makes it possible to efficiently determine the shape and position while checking the size of the object by means of a slide operation.

### Effect of the Disclosure

According to this disclosure, it is possible to efficiently and accurately support drawing in a computer terminal.

### Embodiments of the Disclosure

### First Embodiment

The first embodiment of a drawing device embodying this disclosure will be described according to FIG. 1 through FIG. 6. In this embodiment, a case in which drawing is performed on a screen displayed on a user terminal 10 will be described.

User terminal 10 is a computer terminal (drawing device) that runs a variety of applications and is used by a user to input and output information.

As shown in FIG. 1, in this embodiment, this user terminal 10 is furnished with a control portion 11, memory 12, communication portion 13, and touch panel display 14.

Control portion 11 performs the processing described below (including display control stage, touch control stage, application run stage, draw stage, SNS processing stage, etc.) As shown in FIG. 1, control portion 11 functions as display control portion 111, touch control portion 112, and application running portion 113, as well as functioning as drawing processing portion 114 and SNS processing portion 115 by running application programs.

Display control portion 111 performs processing that controls the display of touch panel display 14. Specifically, it controls the hierarchy (display layer) of the display screen output on touch panel display 14. In this embodiment, it includes a drawing layer that performs drawing and an operation layer positionally synchronized with this drawing layer that displays the cursor and shape outline.

Touch control portion 112 performs processing that detects a touch on touch panel display 14.

Application running portion 113 manages the loading and running of applications example, information sharing, social network service, etc.) stored in user terminal 10.

Drawing processing portion 114 performs processing that controls the drawing of lines and shapes on touch panel display 14. Drawing processing portion 114 outputs a screen to the above-described drawing layer. In this embodiment, the HTML5 canvas element “Canvas API” is used in the drawing layer and the HTML DOM (Document Object Model) is used in the operation layer. This makes it possible to reduce the processing burden on the drawing layer. Updating of cursor location information on the operation layer is performed frequently, hut updating of shapes on the drawing layer is performed less frequently to reduce processing load, e.g. only when a new object is added.

SNS processing portion 115 performs processing using social network service (SNS). Here, web display is performed by displaying a screen on touch panel display 14 of user terminal 10 based on data generated by user terminal 19 (drawing device) and a communication-capable user device (not shown in the drawing).

Memory 12 stores information used for drawing on touch panel display 14. For example, slide trajectories detected on touch panel display 14 and shapes (objects) generated by these slide trajectories are temporarily stored. For example, objects generated on the drawing layer can be updated when the location information for the cursor on the operation layer is updated, or when instructed to temporarily store a drawing, or when the drawing program has stopped.

Communication portion 13 performs communication between the user device and other user terminals on a network.

Touch panel display 14 functions as a display means and input means. Specifically, by outputting information onto the panel and contacting (touching) the panel's screen, a variety of operations (such as touch, slide, swipe, flip, etc.) can be performed by sensing the information at the location of the screen that was touched.

### Hardware Configuration Example

FIG. 2 is a hardware configuration example for user terminal 10.

User terminal 10 has a communication interface H11, input device H12, display device H13, memory portion H14, and processor H15. Note that this hardware configuration is merely an example, and it is acceptable to use other hardware.

Communication interface H11 is the interface that performs transmission and reception of data by establishing a communication route with other devices, and serves as communication portion 13. This can be, for example, a network interface card, wireless interface, etc.

Input device H12 is the device that receives input from the user, etc. Display device H13 is a display or the like that displays various kinds of information. In this embodiment, a touch panel display 14 is used as input device H12 and display device H13.

Memory portion H14 is a memory device that stores programs and data used to implement the various functions of user terminal 10, and serves as memory 12. Examples of memory portion H14 include ROM, RAM, hard disk, etc.

Processor H15 serves as control portion 11, which controls various forms of processing in user terminal 10 using programs and data stored in memory portion H14, Examples of processor H15 include a CPU, MPU, etc. This processor H15 executes the various processes corresponding to the various forms of processing by loading into RAM programs stored in ROM or the like.

### Operation of User Terminal 10

Next, the operation of this user terminal 10 will be described using FIG. 3 through FIG. 6. When a user wishes to draw in a designated application, the draw function is specified using the touch panel display 14 of the user terminal 10.

In this case, as shown in FIG. 3, the Application running portion 113 of control portion 11 activates drawing processing portion 114 and SNS processing portion 115 and outputs display screen 200 to touch panel display 14. A tool menu 210 and drawing area 220 are displayed on this display screen 200.

In the tool menu 210 are displayed a draw button 211, eraser button 212, shape button 213, text button 214, camera button 215, assist button 216, etc.

Draw button 211 is used to display the tool screen, which is used to select the line type (drawing tool) used to draw a line drawing in drawing area 220.

Eraser button 212 is used to display the eraser tool, which is used to erase a portion of the line drawing or shape displayed in drawing area 220.

Shape button 213 is used to display the shape tool, which is used to place a pre-prepared shape (for example, square, circle, arrow, heart, etc.) in the drawing area 220.

Text button 214 is used to display a software keyboard, which is used to input text into the drawing area 220.

Camera button 215 is used to display an image photographed by a camera or the like in drawing area 220.

Assist button 216 is a button that provides the function of supporting drawing in drawing area 220. Selecting this assist button 216 causes a list of various assist functions to be pulled down. In this embodiment, assist functions include functions such as “pointer mode,” “enlarged/reduced mode,” “temporary save,” “temporary save call,” “help,” etc.

“Pointer mode,” as described below, is the function that supports drawing at an operation location a certain distance from the drawing location.

“Enlarged/reduced mode” is the function that performs enlarging and reducing of the drawing area 220.

“Temporary save” is the function that temporarily stores the drawn content in drawing area 220 into memory 12, and “temporary save call” is the function that calls the image content temporarily stored in memory to drawing area 220.

“Help” is the function that outputs a description of the various buttons displayed on the tool menu 210 and the like in a balloon icon.

### Pointer Mode Processing

Pointer mode processing when “pointer mode” is specified using assist button 216 will be described using FIG. 4. In this pointer mode processing, when a line drawing is drawn using the line drawing tool, for example, a line drawing can be drawn by performing a slide operation at a location a certain distance from the area where drawing is to be performed.

First, control portion 11 of user terminal 10 performs processing that specifies the drawing tool (step S1-1). Specifically, in tool menu 210, draw button 211 is selected. In this case, the drawing processing portion 114 of control portion 11 outputs a tool screen to touch panel display 14. This tool screen includes a select screen for the line type (color, thickness, transparency, border, etc.) for drawing a line drawing.

Next, control portion 11 of user terminal 10 performs processing that sets the drawing start location (step S1-2), Specifically, when drawing a line drawing, the start location of the line drawing is tapped in drawing area 220 by briefly touching touch panel display 14. In this case, touch control portion 112 of control portion 11 identifies the tapped location (coordinates) in drawing area 220. Drawing processing portion 114 then positions a pointer (cursor) for drawing a line drawing at the tapped location.

As shown in FIG. 3, when a tap is detected in drawing area 220, drawing processing portion 114 displays a pointer 230. As described below, this pointer 230 functions as a pen, and a line drawing can be drawn by moving pointer 230.

Next, control portion 11 of user terminal 10 performs processing that sets the operation start location (step S1-3). Specifically, when drawing a line drawing using the positioned pointer, any location in drawing area 220 is touched again. Here, a location different from the drawing start location can be touched. In this case, drawing processing portion 114 of control portion 11 sets the second touched location as the operation start location.

Here, if the coordinates of drawing area 220 are expressed as (x, y), a calibration vector (x3, y3) from the coordinates of the operation start location (x2, y2) to the coordinates of the drawing start location (x1, y1) is computed [=(x1−x2, y1−y2)].

Next, control portion 11 of user terminal 10 performs processing that makes a determination regarding touch-off (step S1-4), Specifically, to draw a line drawing, the touch position is moved by sliding while continuing to touch the operation layer. Touch control portion 112 of control portion 11 waits for the touch to be released from touch panel display 14 (touch-off) while detecting the sliding of the touch position.

In this case, the pointer location (xi+x3, yi+y3) for the coordinates of the new slide location (xi, yi) is computed using the calibration vector (x3, y3), and drawing is performed at this pointer location.

If touch-off is not determined to have occurred (“NO” in step S1-4), control portion 11 of user terminal 10 performs drawing processing in accordance with the slide path (step S1-5). Specifically, touch control portion 112 of control portion 11 moves the pointer in the same way as the slide path, which has as its starting point the operation start location. In this case, the touch location (coordinates) and the pointer location where drawing is to occur (coordinates) retain the relative locational relationship that exists between the operation start location (coordinates) and the drawing start location (coordinates). As a result, drawing processing portion 114 displays the same line drawing as the slide path from the drawing start location in drawing area 220.

As shown in FIG. 5, moving pointer 230 in the same way as slide path 240 produces a line drawing 241 at a location a certain distance from slide path 240.

In contrast, when touch-off is determined to have occurred (“YES” in step S1-4), control portion 11 of user terminal 10 performs object setting processing (step S1-6). Specifically, drawing processing portion 114 of control portion 11 writes the line drawing 241 drawn by the pointer as an object on the display layer.

To produce a new line drawing on the completed line drawing 241, this processing is repeated starting from setting the drawing start location (step S1-2),

For example, to draw a new line drawing connected to the initial line drawing 241, as shown in FIG. 6, drawing start location 242 is set by tapping the connection point. Next, any location in drawing area 220 is touched once more and the finger is slid along slide path 243, which has as its starting point this operation start location. In this case, a new line drawing 244 is produced.

SNS processing portion 115 then uses social network service with an image containing this line drawing 244 object.

According to this embodiment, the effects indicated below can be obtained.

(1) In the aforesaid embodiment, control portion 11 of user terminal 10 performs setting processing for the drawing start location (step S1-2), setting processing for the operation start location (step S1-3), and drawing processing according to the slide path (step S1-5). This makes it possible to draw using a touch operation at a location different from the drawing area. Accordingly, this makes it possible to accurately and efficiently draw without the drawing area being obscured by the finger during a touch operation, Furthermore, the operation start location can also be set arbitrarily, which makes it possible to perform slide operations in the area most convenient to the user,

### Second Embodiment

Next, a second embodiment will be described using FIG. 7 through FIG. 12. The first embodiment described a case in which a line drawing is created. The second embodiment is a configuration in which a shape is created with the first embodiment, and hence identical components will not be described in detail.

To draw using a shape, the shape button 213 is selected on the tool menu 210 in FIG. 3. In this case, drawing processing portion 114 of control portion 11 outputs a tool screen. This tool screen includes a select screen for the shape used for drawing (for example, square, round, arrow, heart, etc) and shape attributes (color, thickness, transparency, outline. etc.). If the “Place” button is pressed on the tool screen, drawing processing portion 114 displays the selected shape object (here, a heart) in the drawing area 220. Here, the shape object can be deformed, rotated, or repositioned.

A plurality of operation areas are provided on the periphery and on the inside of the shape object 300, as shown in FIG. 7. In this embodiment, 9 operation areas are provided on the periphery and on the inside of the object 300. Object 300 can be transformed by performing a slide operation (move) along the line segment between peaks 301-304 of the rectangle surrounding object 300. Furthermore, the entirety of object 300 can be moved by performing a slide operation (move) within object 300.

For this reason, transform operation areas 311-314 are provided around peaks 301-304, respectively. For the size of transform operation areas 311-314, by way of example, a square measuring a designated proportion of the short side of the rectangle or comprised of sides of a designated length is used. Touching transform operation area 311 and performing a slide operation changes the location of peak 301. Touching transform operation area 312 and performing a slide operation changes the location of peak 302. Touching transform operation area 313 and performing a slide operation changes the location of peak 303. Touching operation area 314 and performing a slide operation changes the location of peak 304.

Additionally, transform operation areas 321-324 are provided corresponding to each side of peaks 301-304. If an operation is performed to move the right side of transform operation area 321 left or right, object 300 is transformed by changing the location of the right side. If an operation is performed to move the left side of transform operation area 322 left or right, object 300 is transformed by changing the location of the left side. If an operation is performed to move the top side of transform operation area 323 up or down, object 300 is transformed by changing the location of the top side. If an operation is performed to move the bottom side of transform operation area 324 up or down, object 300 is transformed by changing the location of the bottom side.

Furthermore, a move operation area 330 is provided within object 300 surrounded by transform operation areas 311-314 and 321-324. If this move operation area 330 is touched and a slide operation is detected, the entirety of object 300 is moved in the slide direction while maintaining the shape of object 300.

Furthermore, an operation area for performing operations on object 300 is provided in the area outside of transform operation areas 311-314 and 321-324. If a slide is detected in the area outside of any of these operation areas, the entirety of object 300 is rotated centered on the axis of object 300 (reference position within object). Note that if the reference position within the object is a pre-defined location, it is not limited to the center of the object.

### Shape Operation Processing

Shape operations using each operation area will be described using FIG. 8.

First, control portion 11 of user terminal 10 performs object select processing (step S2-1), Specifically, shape button 213 is selected in tool menu 210. In this case, drawing processing portion 114 of control portion 11 outputs a tool screen to touch panel display 14. Using this tool screen, the shape or shape attributes to be used for drawing are selected.

Next, control portion 11 of user terminal 10 performs object placement processing (step S2-2). Specifically, the Place button on the tool menu is selected. In this case, drawing processing portion 114 of control portion 11 places an object 300 with the selected shape in drawing area 220.

Next, control portion 11 of user terminal 10 performs identification processing for the touch location (step S2-3). Specifically, touch control portion 112 of control portion 11. identifies the coordinates of the touch location on object 300 within drawing area 220.

Next, control portion 11 of user terminal 10 performs processing to determine whether the touch location was within the bounds of the object (step S2-4). Specifically, drawing processing portion 114 of control portion 11 identifies the positional relationship between the touch location and the operation area set for object 300. If the touch location is within transform operation areas 311-314 or 321-324 or move operation area 330, the touch location is determined to be within the bounds of the object.

If the touch location is determined not to be within the bounds of the object (“NO” in step S2-4), control portion 11 of user terminal 10 performs processing to compute the rotary angle of the slide path (step S2-5). Specifically, to rotate an object, a slide operation is performed from the touch location (slide start location) to the exterior of transform operation areas 311-314 or 321-324 or move operation area 330. In this case, touch control portion 112 of control portion 11 computes the spread angle (rotary angle) from the slide start location to the current touch location relative to the center of the shape object.

Next, control portion 11 of user terminal 10 performs a rotation operation on the object centered on the rotary angle (step S2-6).

Specifically, drawing processing portion 114 of control portion 11 rotates object 300 according to this rotary angle. The placement of object 300 is set upon the occurrence of touch-off from the slide operation.

As shown in FIG. 9, the spread angle (rotary angle) of slide path 400 from the first detected touch location (slide start location) to the current touch location is computed from the center of object 300. Object 300 is then rotated using this rotary angle. Drawing processing portion 114 then finalizes the placement of object 300 upon the occurrence of touch-off from the slide operation, and SNS processing portion 115 uses social network service with an image containing this object.

In contrast, if the touch location is determined to be within the bounds of the object (“YES” in step S2-4), control portion 11 of user terminal 10 performs processing to determine whether or not the operation is a move operation (step S2-7). Specifically, touch control portion 112 of control portion 11 determines that the operation is a move operation if the touch location falls within move operation area 330.

If the operation is determined to be a move operation (“YES” in step S2-7), control portion 11 of user terminal 10 performs a move operation on the object according to the slide path (step S2-8). Specifically, drawing processing portion 114 of control portion 11 moves object 300 according to the slide path. Drawing processing portion 114 then finalizes the placement of object 300 upon touch-off from the slide operation, and SNS processing portion 115 uses social network service with an image containing this object.

As shown in FIG. 10, if the operation is determined to be a move operation, object 300 is moved according to slide path 410.

In contrast, if the touch location is within transform operation areas 311-314 or 321-324, the operation is determined to be a transform operation. If the operation is determined to be a transform operation (“NO” in step S2-7), control portion 11 of user terminal 10 performs transform processing on the object according to the slide path (step S2-9). Specifically, drawing processing portion 114 of control portion 11 transforms object 300 according to transform operation areas 311-314 or 321-324. Drawing processing portion 114 then finalizes the shape of object 300 upon touch-off from the slide operation, and SNS processing portion 115 uses social network service with an image containing this object.

If a touch is detected in transform operation area 321, the right side of object 300 is moved left or right to produce object 420, a transformed version of object 300, as shown in FIG. 11.

Furthermore, if touch is detected in transform operation area 312, the peak 302 of object 300 is moved to produce object 430, a transformed version of object 300, as shown in FIG. 12.

According to the above embodiment, the effects indicated below can be obtained.

(2) In the aforesaid embodiment, transform operation areas 311-314 and 321-324 are set for object 300. In some instances when attempting to transform a shape by touch operation, it may not be possible to use the finger to accurately select a peak or a line segment if the area is too small. In view of this, an operation area provided on the periphery of the peak and line segment makes it possible to efficiently and accurately perform transformation.

(3) in the aforesaid embodiment, an operation area for performing operations on object 300 is also provided in the area outside of transform operation areas 311-314 and 321-324. If the touch location is determined not to fall within the bounds of the object “NO” in step S2-4), control portion 11 of user terminal 10 computes the rotary angle of the slide path (step S2-5) and rotates the object according to the rotary angle (step S2-6). By this means, performing a slide operation to a position a certain distance from the object makes it possible to change the placement of an object while observing its status.

### Third Embodiment

Next, a third embodiment will be described using FIG. 13. The first embodiment described a case in which a line drawing is created, and the second embodiment described a case in which a shape is created. In this case, color is determined by using, for example, a color palette on the tool screen or the like. The third embodiment is a configuration in Which the color of the line drawing or shape is determined using the attributes of the object displayed in the drawing area (in this case color), and hence identical components will not be described in detail.

### Color Determination Processing

Color determination processing will be described using FIG. 13.

First, control portion 11 of user terminal 10 performs long press detection processing (step S3-1). Specifically, to activate the dropper function, which is used to choose a color by pointing to any color displayed on the screen, a long press operation is performed by touching drawing area 220 for an extended period. In this case, touch control portion 112 of control portion 11 measures the length of time that the same location has been touched, and makes a determination that a long press operation has been performed if this length of time exceeds a long press reference time.

Next, control portion 11 of user terminal 10 performs color extraction processing for the pointer location (step S3-2). Specifically, drawing processing portion 114 of control portion 11 places the pointer at the location where the long press operation was performed. Drawing processing portion 114 then extracts the color at the location where the pointer was placed. Drawing processing portion 114 also displays the color extracted from the drawing area on the color select screen of the tool screen (attribute display area). Here, if a slide operation is performed [at] the pointer location (touch location) while touching touch panel display 14, drawing processing portion 114 continues color extraction processing at the pointer location (step S3-2).

Next, control portion 11 of user terminal 10 performs processing to determine whether or not touch-off has occurred (step S3-3). Specifically, touch control portion 112 of control portion 11 waits for touch to be released (touch-off) while following the sliding of the touch location on touch panel display 14.

If touch-off is determined not to have occurred (“NO” in step S3-3), control portion 11 of user terminal 10 continues color extraction processing at the pointer location (step S3-2).

If touch-off is determined to have occurred (“YES” in step 53-3), control portion 11 of user terminal 10 performs color setting processing (step S3-4). Specifically, drawing processing portion 114 of control portion 11 sets the color at the pointer location at the time of touch-off on the tool screen. This makes it possible to position line drawings and shapes using this color.

According to the above embodiment, the effects indicated below can be obtained.

(4) In the aforesaid embodiment, control portion 11 of user terminal 10 performs long press detection processing (step S3-1) and color extraction processing at the pointer location (step S3-2). If touch-off is determined to have occurred (“YES” in step S3-3), control portion 11 of user terminal 10 performs color setting processing (step S3-4). This makes it possible to select any desired color while checking the color on the tool screen, which is not in the same location as the touch location.

### Fourth Embodiment

Next, a fourth embodiment will be described using FIG. 14. The third embodiment described a case in which color was extracted at the pointer location and used in drawing. The fourth embodiment is a configuration for outputting color candidates, and hence identical components will not be described in detail. In this case, drawing processing portion 114 stores the history of used colors as well as colors specified by the user as color candidates.

### Color Determination Processing

Color determination processing will be described using FIG. 14.

First, as in step S3-1, control portion 11 of user terminal 10 performs long press detection processing (step S4-1).

In this case, control portion 11 of user terminal 10 performs output processing of color candidates. Specifically, drawing processing portion 114 of control portion 11 outputs color candidates around the pointer. For example, different color candidates are output in a cross shape to the left, right, above, and below the pointer. The stored color history or user-specified colors can be used as color candidates. Note that outputting of color candidates is not limited to a cross shape, and need merely occur near the location of the long press operation.

Next, control portion 11 of user terminal 10 performs processing to determine whether or not a flick has occurred (step S4-2). Specifically, touch control portion 112 of control portion 11 makes a determination that a flick operation has occurred if it detects that a finger used to perform a touch is flicked or moved quickly.

If a flick is determined to have occurred (YES″ in step S4-2), control portion 11 of user terminal 10 performs processing to identify the color according to the flick direction (step S4-3). Specifically, drawing processing portion 114 of control portion 11 identifies the color candidate set in the flick direction as the color to use for drawing.

In contrast, if a flick is not determined to have occurred (“NO” in step S4-2), as in the case of steps S3-2 through S3-4, control portion 11 of user terminal 10 performs color extraction processing at the pointer location (step S4-4), processing to determine whether or not touch-off has occurred (step S4-5), and color setting processing (step S4-6).

According to this embodiment, the effects indicated below can be obtained in addition to the effects described in (4) above.

(5) In the aforesaid embodiment, control portion 11 of user terminal 10 performs output processing for color candidates. If a flick is determined to have occurred (“YES” in step S4-2), control portion 11 of user terminal 10 performs processing to determine the color according to the flick direction (step S4-3). This makes it possible to efficiently select color by means of color candidates.

### Fifth Embodiment

Next, a fifth embodiment will be described using FIG. 15. The second embodiment described a case in which a shape object was placed, moved, and transformed. The fifth embodiment is a configuration for transforming a shape object during placement, and hence identical components will not be described in detail. In this case, a start point and end point are set for shape objects that can be used in drawing.

### Shape Generation Processing

Shape generation processing will be described using FIG. 15.

First, as in step S2-1, control portion 11 of user terminal 10 performs object select processing (step S5-1).

Next, control portion 11 of user terminal 10 performs start point setting processing at the first tapped location (step S5-2).

Specifically, to draw the selected object, the location within drawing area 220 where to start drawing the object is tapped. In this case, touch control portion 112 of control portion 11 determines the tap location (coordinates) that was touched within drawing area 200. Drawing processing portion 114 then sets this tap location as the starting location for drawing of the object (start point).

Next, control portion 11 of user terminal 10 performs processing to determine the second touch (step S5-3). Specifically, drawing area 220 is touched again to choose where to place the object's end point. In this case, touch control portion 112 of control portion 11 identifies the touch location (coordinates) within drawing area 220.

Next, control portion 11 of user terminal 10 performs processing to set the end point as the touch location (step S5-4). Specifically, drawing processing portion 114 of control portion 11 sets the location of the drawing end point for the object to this touch location.

Next, control portion 11 of user terminal 10 performs processing to transform the object at the start point and end point (step S5-5). Specifically, drawing processing portion 114 of control portion 11 sets the start point and end point of the object as the drawing start location and drawing end location and displays the object in drawing area 220.

Next, control portion 11 of user terminal 10 performs processing to determine whether or not touch-off has occurred (step S5-6). Specifically, to transform an object, the touch location is slid. In this case, drawing processing portion 114 of control portion 11 transforms the shape by following the end point of the object according to the slide operation. Drawing processing portion 114 then waits for touch to be released from touch panel display 14 (touch-off).

If touch-off is not determined to have occurred (“NO” in step S5-6), control portion 11 of user terminal 10 continues transformation processing of the object at the start point and end point (step S5-5).

In contrast, if touch-off is determined to have occurred (“YES” in step S1-4), control portion 11 of user terminal 10 performs object setting processing (step S5-7). Specifically, drawing processing portion 114 of control portion 11 generates an object with the touch-off location as the end point, and SNS processing portion 115 uses social network service with an image containing this object.

According to this embodiment, the effects indicated below can be obtained.

(6) In the aforesaid embodiment, control portion 11 of user terminal 10 performs start point setting processing at the first tap location (step S5-2), end point setting processing at the touch location (step S5-4), and object transformation processing at the start point and end point (step S5-5), This makes it possible to determine the shape and placement of the object by setting the start point and end point and performing a slide operation.

Note that the aforesaid embodiment can be altered into the following form.

In the aforesaid first embodiment, control portion 11 of user terminal 10 performs setting processing for the drawing tool (step S1-1). Here, draw button 211 is selected in tool menu 210. Alternately, pointer mode processing can be performed if eraser button 212 is selected. In this case, drawing processing portion 114 specifies the size of the eraser tool in the tool screen. A portion of the shape can be erased by drawing a line with the background color. In this case, too, control portion 11 of user terminal 10 sets the erase start location during setting processing for the drawing start location (step S1-2) and performs erasing according to the path by means of setting processing for the operation start location (step S1-3) and drawing processing according to the slide path (step S1-5).

In the aforesaid first embodiment, the calibration vector (x3, y3) from the operation start location coordinates to the drawing start location coordinates are computed. Here, the method for determining the calibration vector is not limited to this. For example, pre-set initial settings for the calibration vector (x4, y4) can be used. In this case, the drawing start location is determined relative to the operation start location using the initial setting for the calibration vector. In short, processing to set the drawing start location (step S1-2) is performed according to the processing to set the operation start location (step S1-3). Note that the calibration vector initial setting element can be set to the same value (x4=y4) or a different value (x4≠y4).

Furthermore, the calibration vector can alternately be set according to user input or operating environment. Specifically, control portion 11 determines the area of the user's touch location (width of finger or width of stylus) and alters the calibration vector according to this value. For example, if the area of the touch location is wide, the calibration vector is increased. This makes for a more pleasing drawing experience that matches user input.

Furthermore, the calibration vector can be altered according to user edits, revision operations, etc. In cases where user input errors may be common, the calibration vector is altered according to the results of user revisions. In this case, the operation start location is made to be alterable relative to the drawing start location. Additionally, an operation history is recorded, e.g., for operations changing the “operation start location during revisions” to beyond the “first input operation start location” relative to the drawing start location. If the number of such alterations exceeds a designated count, this can be changed so as to increase the calibration vector. This makes it possible to draw according to the drawing attributes of each user.

Furthermore, the calibration vector can be altered according to the width of drawing area 220, the thickness of the object (pen) used for drawing, or the size of the drawing medium (narrow area or wide area). This provides a more pleasing drawing environment and permits more flexible input.

In the aforesaid second embodiment, control portion 11 of user terminal 10 performs processing to identify the touch location (step S2-3). Control portion 11 of user terminal 10 then performs processing to determine whether or not this was done within the bounds of the object (step S2-4) and Whether or not a move operation was performed (step S2-7). Alternately, the operation (transform, move, rotate) can be determined from the first tap, as in the case of pointer mode processing, but a slide operation can be performed with the second touch, and the amount of transformation, the amount of the move, or the rotary angle can be determined according to the slide path. This makes it possible to set an object without the finger getting in the way during the operation.

In the aforesaid third and fourth embodiments, the color of a line drawing or shape is determined using the drawing area. Here, color is not the only attribute that can be obtained with the dropper function. For example, visual attributes such as patterns and the like as well as other attributes such as an object's allocated name can be obtained.

In the aforesaid first embodiment, control portion 11 of user terminal 10 performs setting processing for the drawing start location (step S1-2), Here, tapping is performed on touch panel display 14. Furthermore, in the aforesaid third embodiment, control portion 11 of user terminal 10 performs long-press detection processing (step S3-1). In the aforesaid fifth embodiment, start setting processing (step S5-2) and second touch detection processing (step S5-3) are performed at the first tap location. Any operation method can be used to initiate these various functions as long as it can be differentiated from the other operations. For example, in the fifth embodiment, the start point and the end point can be set according to the touch location and the touch-off location.

In the aforesaid embodiments, an image containing the drawn object is used with social network service. Drawings are not limited to being used with social network service, and can be used with any applications that use line drawings or shapes (games, etc.

In the aforesaid embodiments, control portion 11 is made to function as the drawing processing portion 114 and SNS processing portion 115 by activating a single application program. Here, drawing processing portion 114 and SNS processing portion 115 can be made to function by separate application programs. Specifically, drawing processing portion 114 can be activated by a drawing processing program, and objects generated by drawing processing portion 114 can be supplied to the functions of other application programs.

In the aforesaid embodiments, web display is performed on the user terminal based on data generated by a server device. Here, at least part of the screen serving to perform drawing (for example, tool menu 210 or drawing area 220) can be native display, which is displayed by native applications installed on the user terminal. It is also possible to use a hybrid application, in which user terminal 10 and the server device each handle a part of the processing.

### DESCRIPTION OF THE SYMBOLS

10: user terminal, 11: control portion, 111: display control portion, 112: touch control portion, 113: application running portion, 114: drawing processing portion, 115: SNS processing portion, 12: memory, 13: communication portion, 14: touch panel display, 241, 244: line drawing, 300, 420, 430: object.

1. A non-transitory computer readable medium including executable instructions, which when executed by a computer cause the computer to execute a drawing processing method of controlling a drawing processing apparatus including a touch panel display, the method comprising:
receiving, via the touch panel display, a first touch operation, the first touch operation tapping a first location on the touch panel display;
storing, in a memory, the first location as a drawing start location;
after storing the first location as the drawing start location, receiving, via the touch panel display, a second touch operation, the second touch operation sliding on the touch panel display from a second location to a third location to draw a first slide trajectory, the second location being different from the first location;
storing, in the memory, the second location as an operation start location; and
based on the drawing start location and the operation start location stored in the memory, controlling the touch panel display to display an object of a second slide trajectory corresponding to the first slide trajectory drawn by the second touch operation such that the displayed object of the second slide trajectory starts from the drawing start location.

2. The non-transitory computer readable medium according to claim 1, wherein
the method further comprises receiving, via the touch panel display, an user input for identifying a drawing mode, and
the first touch operation is received, and the first location is stored in the memory as the drawing start location after receiving the user input for identifying the drawing mode.

3. The non-transitory computer readable medium according to claim 1, wherein
the method further comprises:
calculating a calibration vector (x3, y3) from coordinates of the operation start location (x2, y2) to coordinates of the drawing start location (x1, y1), where the calibration vector x3, y3)=(x1−x2, y1−y2); and
controlling the touch panel display to display the object of the second slide trajectory by calibrating the first slide trajectory using the calibration vector x3, y3).

4. The non-transitory computer readable medium according to claim 1, wherein
the method further comprises:
determining whether the second touch operation is released from the touch panel display; and
setting the object when the second touch operation is determined to be released from the touch panel display.

5. The non-transitory computer readable medium according to claim 1, wherein
the method further comprises displaying a pointer at the drawing start location on the touch panel display when the first touch operation is received.

6. The non-transitory computer readable medium according to claim 5, wherein
the controlling controls the touch panel display to display the object by moving the pointer in a same way as the first slide trajectory, while retaining a relative locational relationship between the drawing start location and the operation start location.

7. The non-transitory computer readable medium according to claim 1, wherein
the method further comprises:
receiving, via the touch panel display, a user selection of a shape object;
positioning the shape object at a fourth location in the touch panel display;
receiving, via the touch panel display, a third touch operation, the third touch operation sliding on the touch panel display from a fifth location to a sixth location to draw a third slide trajectory, the fifth location being different from the fourth location; and
moving the shape object on the touch panel display based on the third touch operation.

8. The non-transitory computer readable medium according to claim 7, wherein
the moving the shape object rotates the shape object based on a rotary angle of the third slide trajectory drawn by the third touch operation.

9. The non-transitory computer readable medium according to claim 7, wherein
the method further comprises calculating a rotary angle of the third slide trajectory drawn by the third touch operation, and
the moving the shape object rotates the shape object such that the shape object is rotated by the calculated rotary angle of the third slide trajectory.

10. The non-transitory computer readable medium according to claim 7, wherein
the method further comprises:
transforming the shape object on the touch panel display in response to a touch operation in a first area of the touch panel display; and
moving the shape object on the touch panel display in response to a touch operation in a second area of the touch panel display different from the first area.

11. The non-transitory computer readable medium according to claim 1, wherein
the method further comprises:
receiving, via the touch panel display, an user input for identifying an erasing mode;
after receiving the user input for identifying the erasing mode, receiving, via the touch panel display, a. third touch operation, the third touch operation tapping a. fourth location on the touch panel display;
storing, in a memory, the fourth location as an erasing start location;
after storing the fourth location as the erasing start location, receiving, via the touch panel display, a fourth touch operation, the fourth touch operation sliding on the touch panel display from a fifth location to a sixth location to draw a third slide trajectory, the fifth location being different from the fourth location;
storing, in the memory, the fifth location as an erasing operation start location; and
based on the erasing start location and the erasing operation start location stored in the memory, controlling the touch panel display to erase at least a part of the displayed object.

12. The non-transitory computer readable medium according to claim 1, wherein
the method further comprises:
identifying attribute information of an object identified by an user input; and
using the identified attribute information for a drawing process.

13. The non-transitory computer readable medium according to claim 12, wherein
the attribute information is identified in response to receiving the user input for identifying the object, the user input for identifying the object being a long press operation on the touch panel display exceeding a predetermined reference time.

14. The non-transitory computer readable medium according to claim 13, wherein
the attribute information is set for the drawing process when the long press operation is determined to be released.

15. The non-transitory computer readable medium according to claim 14, wherein
the attribute information is set based on a flick direction on the touch panel display when the long press operation is released.

16. The non-transitory computer readable medium according to claim 12, wherein
the attribute information is at least one of color information, pattern information, and object's allocated name information.

17. A drawing processing apparatus, comprising
a touch panel display;
a memory; and
circuitry configured to
receive, via the touch panel display, a first touch operation, the first touch operation tapping a first location on the touch panel display;
store, in the memory, the first location as a drawing start location;
after storing the first location as the drawing start location, receive, via the touch panel display, a second touch operation, the second touch operation sliding on the touch panel display from a second location to a third location to draw a first slide trajectory, the second location being different from the first location;
store, in the memory, the second location as an operation start location; and
based on the drawing start location and the operation start location stored in the memory, control the touch panel display to display an object of a second slide trajectory corresponding to the first slide trajectory drawn by the second touch operation such that the displayed object of the second slide trajectory starts from the drawing start location,

18. The drawing processing apparatus according to claim 17, wherein
the circuitry is further configured to:
calculate a calibration vector (x3, y3) from coordinates of the operation start location (x2, y2) to coordinates of the drawing start location (x1, y1), where the calibration vector (x3, y3)=(x1−x2, y1−y2); and
control the touch panel display to display the object of the second slide trajectory by calibrating the first slide trajectory using the calibration vector (x3, y3).

19. A drawing processing method of controlling a drawing processing apparatus including a touch panel display, the method comprising:
receiving, via the touch panel display, a first touch operation, the first touch operation tapping a first location on the touch panel display;
storing, in a memory, the first location as a drawing start location;
after storing the first location as the drawing start location, receiving, via the touch panel display, a second touch operation, the second touch operation sliding on the touch panel display from a second location to a third location to draw a first slide trajectory, the second location being different from the first location;
storing, in the memory, the second location as an operation start location; and
based on the drawing start location and the operation start location stored in the memory, controlling the touch panel display to display an object of a second slide trajectory corresponding to the first slide trajectory drawn by the second touch operation such that the displayed object of the second slide trajectory starts from the drawing start location.

19. The drawing processing method according to claim 19, the method further comprising:
calculating a calibration vector (x3, y3) from coordinates of the operation start location (x2, y2) to coordinates of the drawing start location (x1, y1), where the calibration vector (x3, y3)=(x1−x2, y1−y2); and
controlling the touch panel display to display the object of the second slide trajectory by calibrating the first slide trajectory using the calibration vector (x3, y3).
